(19) United States
(12) Patent Application Publication
(10) Pub. No.: US 2013/0248571 A1
(43) Pub. Date: Sep. 26, 2013

(54) FASTENER

(71) Applicant: Scott Jones, Brooklyn, NY (US)

(72) Inventor: Scott Jones, Brooklyn, NY (US)

(21) Appl. No.: 13/428,030

(22) Filed: Mar. 23, 2012

(51) Int. Cl. B62J 11/00; F16B 1/00

(52) U.S. Cl. 224/463; 24/457

(57) ABSTRACT

A fastener for fastening a locking device to a bicycle is provided. The fastener includes a base having a pair of flexible extensions, each extension having an extension hole, and a rigid rod extending through the base and extending therefrom on both sides. One of the extensions is sized to wrap over a bicycle part and to hook to one end of the rod, and the other of the extensions is sized to wrap over locking device and to hook to the other end of the rod to fasten the locking device to the bicycle.

This application relates to the field of fasteners for securing articles, and more particularly, to secure bicycle accessories such as locks to a bicycle frame.

### BACKGROUND INFORMATION

In order to prevent theft or unauthorized use of bicycles, bicycle locks are used to secure the bicycles. However, such locks tend to be bulky and an easy transport on the bike is not always possible.

Several fasteners are known in the related art. U.S. Pat. No. 5,395,018, for example, describes a mount for securing a lock at the top end of the bicycle by using a plurality of the described mounting locks. U.S. Pat. No. 6,422,422 B1 and U.S. Pat. No. 5,833,188 use devices to secure a lock to a bike using straps that are not expandable. U.S. Pat. No. 6,422,422 B1, U.S. Pat. No. 6,843,456 B1, US 2005/0011921A1, US 2006/0124679 A1, and U.S. Pat. No. 5,167,353 use connectors to connect the fastening elements permanently to the bicycle frame. U.S. Pat. No. 5,692,268 describes a flexible strap to secure objects to a bicycle frame.

The possibility to attach and remove the lock quickly from the fastener securing it to the frame is advantageous in the day to day use of the bicycle. Also, due to the limited space on the bicycle frame, it is advantageous if the lock and the fastener can be placed and removed without the use of any installation equipment on the frame as need be.

### SUMMARY OF THE INVENTION

In accordance with a first embodiment of the present invention, a fastener for fastening a locking device to a bicycle is provided. The fastener includes a base having a pair of flexible extensions, each extension having an extension hole, and a rigid rod extending through the base and extending therefrom on both sides. One of the extensions is sized to wrap over a bicycle part and to hook to one end of the rod, and the other of the extensions is sized to wrap over locking device and to hook to the other end of the rod to fasten the locking device to the bicycle.

In accordance with a second embodiment of the present invention, a fastener for fastening an accessory to a bicycle is provided. The fastener includes a base having a first lateral side, an opposing second lateral side, a top side and a bottom side, the top side and first lateral side meeting at a first end, the bottom side and second lateral side meeting at a second end. A first rigid extension extends outward from the first lateral side and a second rigid extension extends outward from the second lateral side. A first flexible extension is provided having a first hole therein, the first flexible extension extending from first end, the first flexible extension being sized to wrap over a bicycle part to be secured to the top side and to have the first hole secured to the second rigid extension. A second flexible extension is provided having a second hole therein, the second flexible extension extending from the second end, the first flexible extension being sized to wrap over an article to be secured to the bottom side and to have the second hole secured to the first rigid extension.

In accordance with a third embodiment of the present invention, a fastener is provided which includes a base having a first lateral side, an opposing second lateral side, a top side and a bottom side, the top side and first lateral side meeting at a first end, the bottom side and second lateral side meeting at a second end. A first rigid extension extends outward from the first lateral side and a second rigid extension extends outward from the second lateral side. A first flexible extension is provided having a first hole therein, the first flexible extension extending from first end, the first flexible extension being sized to wrap over an article to be secured to the top side and to have the first hole secured to the second rigid extension. A second flexible extension is provided having a second hole therein, the second flexible extension extending from the second end, the first flexible extension being sized to wrap over an article to be secured to the bottom side and to have the second hole secured to the first rigid extension.

In the embodiments described above, the base and the extensions may be formed as a single piece, and are preferably made of an elastomer, most preferably a thermoplastic elastomer. Preferably, the base has recesses on opposing (e.g. top and bottom) sides to receive a bicycle frame on one side and a lock on the other side.

The rigid extensions described in connection with the second and third embodiments may be formed as a rod, and the rigid extensions and/or rod of all three embodiments are preferably made of a material selected from the group of metal and plastic. Preferably, each rigid extension, or each end of the rod, has a recess to receive one of the flexible extension holes.

Alternatively, the base can be made of a rigid material (such as metal or plastic) with a covering made of an elastomeric material. The extensions can be made of an elastomeric material and form a single piece with the covering. The rigid extensions can be formed as one piece with the base, or separately therefrom. The elastomeric covering may also cover the rigid extensions.

### BRIEF DESCRIPTION OF THE DRAWINGS

The present invention will be further described with respect the following Figures, in which:

FIG. 1 is a perspective view of a fastener for securing a bicycle lock to a bicycle in accordance with an embodiment of the present invention.

FIG. 2 is a view of the fastener of FIG. 1 from a front or back view, the front and back views being identical.

FIG. 3 is a view of the fastener of FIG. 1 from a top or bottom view, the top and bottom views being identical

FIG. 4 is a view of the fastener of FIG. 1 from a side view, both side views being identical.

FIG. 5 is a view of the fastener of FIG. 1 attaching a bicycle lock to a bicycle frame.

### DETAILED DESCRIPTION OF PREFERRED EMBODIMENTS OF THE INVENTION

It is an object of the present invention to provide a fastener to attach a bicycle lock to a bicycle in a convenient and fast way. However, it should be appreciated that the present invention can also be used to secure other accessories to a bicycle, or for that matter, to secure other articles to eachother.

The present invention provides a fastener for fastening a locking device to a bicycle comprising a base having a pair of flexible extensions each having a hole. The fastener also includes a first rigid extension and a second rigid extension, preferably in the form of a rod or bar extending through the base. One flexible extension is sized to wrap over a bicycle frame and to hook onto one rigid extension. The other flexible extension is sized to wrap over the locking device to hook onto the other rigid extension to fasten the locking device to the bicycle.

In this regard, the base can be described as having a first lateral side having the first rigid extension, an opposing second lateral side having the second rigid extension, a top side and a bottom side, where the top side and first lateral side meeting at a first end, the bottom side and second lateral side meeting at a second end. The first and second flexible extensions preferably extend from the first and second ends respectively.

The base and both extensions are preferably made of one piece of elastic material, e.g. of an elastomer via injection molding. Most preferably, the base, including both extensions, are made as a one piece thermoplastic elastomer (TPE) base. The rod or bar is made of a rigid material, e.g. of metal or hard plastic, most preferably aluminum or a thermoset hard plastic.

The rod preferably passes through a bore in the base and extends beyond the base on both sides. Recesses are located at both ends of the rod, preferably on opposite sides of the rod, to receive the extensions.

The base is configured to preferably have recesses on opposite sides, each recess having an extension on one side and a stub on the other. The extension and the stub are located vice versa on the opposite recess. The recesses are preferably concave shaped to mate with the bicycle frame and bicycle lock.

As explained above, the recesses on opposing ends of the rod receive associated extensions of the base, with the extension holes resting in the recesses. The recesses on the rod can be U-shaped, V-shaped or otherwise shaped to face an opposite direction as the base recess around which its associated extension is wrapped. Alternatively, the recesses on the rod can extend circumferentially around the rod.

The holes located in the extensions can be oval-shaped. Preferably both extensions are substantially identical, so that they can be used interchangeably. However, alternatively, one of the recesses, holes and extensions can be of another size than the other of the recesses, holes and extensions.

In operation, one of the recesses in the base is placed against the bicycle frame and its associated extension is wrapped over the bicycle frame and secured to the recess on one side of the rod (“rod recess”) by stretching a distal end of the hole of the extension over the rod and resting it in the rod recess. Then, the bicycle lock is placed against the other recess in the base, and the other extension is wrapped over the bicycle lock and secured to the recess on the other side of the rod (“other rod recess”) by stretching a distal end of the hole of the other extension over the rod and resting it in the other rod recess. Once the fastener is removed from the lock and bicycle, the elastomeric base preferable returns to its original shape as discussed below.

FIG. 1 shows a perspective view of a fastener 1 according to a preferred embodiment of the present invention and FIG. 4 shows a side view of the fastener. Fastener 1 includes a base 10 and a rod 20. Base 10 is provided with a middle section 16 and extensions 11 having openings 12. Middle section 16 is configured to have recesses 13 on opposite sides to each other and sides 15, also opposite to each other. Although the base is symmetrical, for ease of reference, recesses 13 can be described as on the top and bottom sides. and sides 15 can be described as first first and second lateral sides. Recesses 13 are formed in such a way so as to fit on a bicycle frame on one recess and so as to receive a bicycle lock on the other recess. Both recesses 13 are have stubs 14 on one side and extensions 11 on the other side. Stubs 14 are arranged diagonal to each other on the upper and lower side of middle piece 16. Extensions 11 are also are arranged diagonal to each other on the upper and lower side of middle piece 16. On each side, stub 14 delimits one end of recess 13, and extension 11 delimits the other end of recess 13 and extends therefrom.

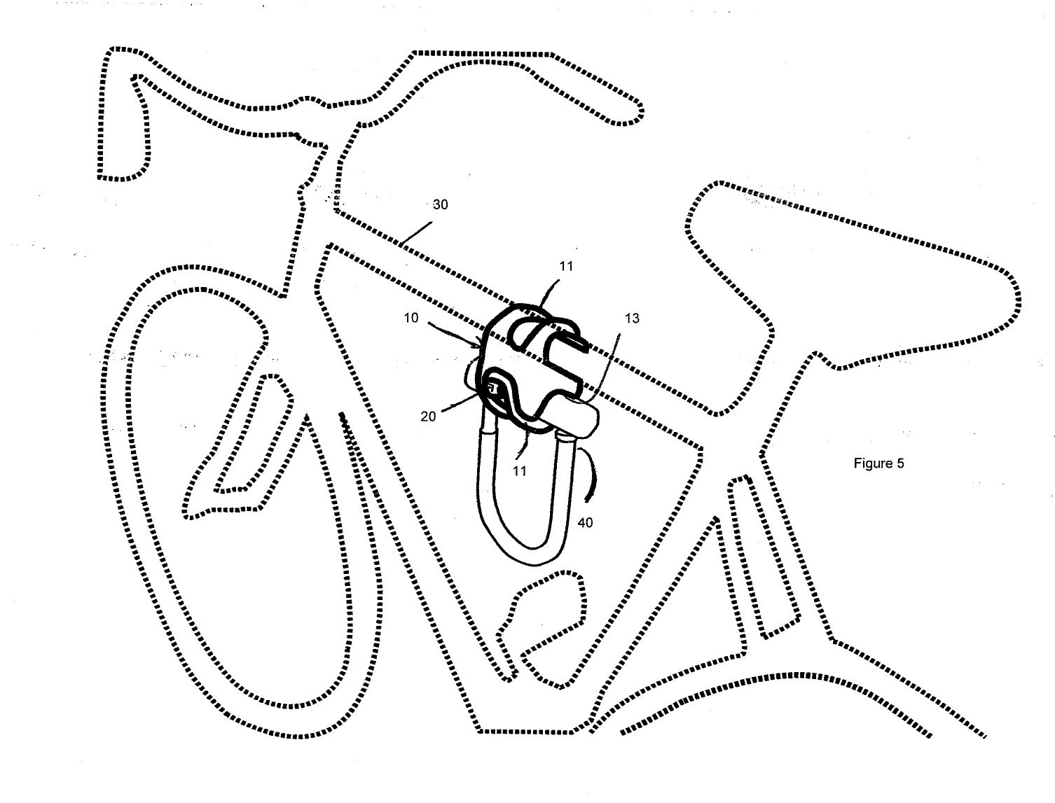

Base 10 is made from an elastic material, e.g. an elastomer and rod or bar 20 is made from a rigid material, e.g. hard plastic or metal. Referring to FIGS. 1 and 5, extensions 11 include openings 12 and are designed to wrap over the bicycle frame 30 on one side and to, wrap over bicycle lock 40 on the other side. The elastic material and base 10 is configured so that after the fastener 1 is unfastened from the lock 40 and frame 30, it will revert back into its original shape as shown in FIG. 1. Most preferably, the base, including both extensions, are made as a one piece thermoplastic elastomer (TPE) base.

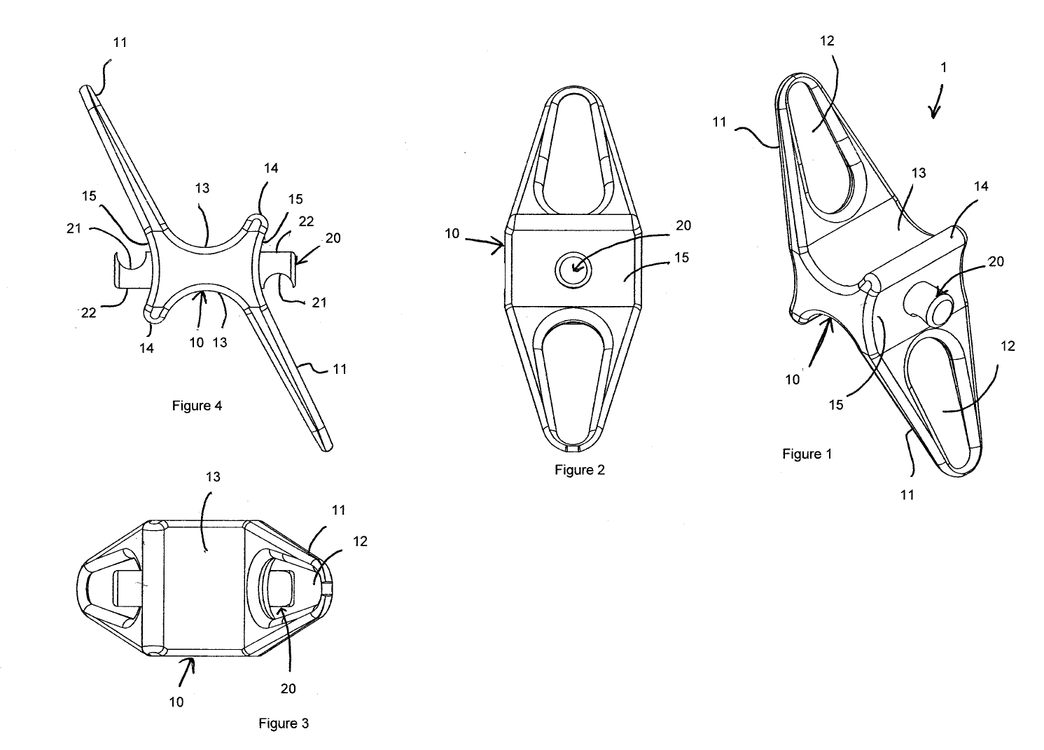

As depicted in FIGS. 1, 2 and 3, rod 20 extends horizontally through a bore in middle piece 16 of base 10 and extends outside of middle piece 16 on both sides 15. Rod 20 has recesses 21 on both ends 22, recesses 21 being on opposite sides of each other, one side facing up the other facing down. Rod can either be permanently fixed in position in the bore, either through a press fit or adhesives, or can be removeably positioned in the bore. Although illustrated as a cylindrical rod, rod 20 can alternatively be formed as a flat bar or rod, or otherwise shaped extension from the base.

Recesses 21 are shaped in such a way so as to receive the end of extensions 11. Due to the elasticity of the material of base 10, extension 11 can be stretched over bicycle frame 30 and lock 40, respectively and openings 12 can be hooked into recesses 21 of rod 20 and fix bicycle 30 and lock 40 in place, as shown schematically in FIG. 5.

Alternatively, the base 10 and/or rod 20 (or bar) could be formed of a rigid material (for example, metal or plastic) that is wrapped in a thin coat of elastomer. The base 10 could be a solid one or two piece rigid member (metal or plastic) that forms two opposing ‘U-shaped’ portions that are back to back. The rod or bar could be formed separately from the base, or be formed integrally with the base (e.g. as a single piece with the base), protruding equally from both sides. The pair of flexible extensions 11 could be solid extensions of the same piece of elastomer that wraps around the solid base 10.

In the preceding specification, the invention has been described with reference to specific exemplary embodiments and examples thereof It will, however, be evident that various modifications and changes may be made thereto without departing from the broader spirit and scope of invention as set forth in the claims that follow. The specification and drawings are accordingly to be regarded in an illustrative manner rather than a restrictive sense.

What is claimed is:

1. A fastener for fastening a locking device to a bicycle comprising,
a base having a pair of flexible extensions, each extension having an extension hole; and
a rigid rod extending through the base and extending therefrom on both sides,
one of the extensions being sized to wrap over a bicycle part and to hook to one end of the rod, the other of the extensions being sized to wrap over locking device and to hook to the other end of the rod to fasten the locking device to the bicycle.

2. The fastener as recited in claim 1, wherein the base and the extensions are formed as a single piece.

3. The fastener as recited in claim 1, wherein the base and the extensions are made by injection molding.

4. The fastener as recited in claim 2, wherein the base and extensions are made of an elastomer.

5. The fastener as recited in claim 4, wherein the elastomer is a thermoplastic elastomer.

6. The fastener as recited in claim 1, wherein the rod is made of a material selected from the group of metal and plastic.

7. The fastener as recited in claim 1, wherein the rod extends through a bore in the base.

8. The fastener as recited in claim 1, each end of the rod has a recess to receive one of the extension holes.

9. The fastener as recited in claim 8, wherein the recesses are U-shaped.

10. The fastener as recited in claim 8, wherein the recesses extend circumferentially around the rod.

11. The fastener as recited in claim 1, wherein the base comprises recesses on opposite sides to receive a bicycle frame on one side and a lock on the other side.

12. A fastener for fastening an accessory to a bicycle, comprising
a base having a first lateral side, an opposing second lateral side, a top side and a bottom side, the top side and first lateral side meeting at a first end, the bottom side and second lateral side meeting at a second end;
a first rigid extension extending outward from the first lateral side;
a second rigid extension extending outward from the second lateral side;
a first flexible extension having a first hole therein, the first flexible extension extending from first end, the first flexible extension being sized to wrap over a bicycle part to be secured to the top side and to have the first hole secured to the second rigid extension;
a second flexible extension having a second hole therein, the second flexible extension extending from the second end, the first flexible extension being sized to wrap over an article to be secured to the bottom side and to have the second hole secured to the first rigid extension.

13. The fastener of claim 12, wherein the article is a bicycle lock.

14. The fastener of claim 12, wherein a bore extends through the base from the first lateral side to the second lateral side, and further comprising a rod extending through the bore, the rod including a first end defining the first rigid extension and a second end defining the second rigid extension.

15. The fastener as recited in claim 12, wherein the base and the extensions are formed as a single piece of elastomeric material.

16. The fastener as recited in claim 12, wherein the base is a made of a rigid material with a covering made of an elastomeric material.

17. The fastener as recited in claim 16, wherein the extensions are made of an elastomeric material and form a single piece with the covering.

18. The fastener as recited in claim 15, wherein the elastomeric material is a thermoplastic elastomer.

19. The fastener as recited in claim 12, wherein the first rigid extension has a first recess to receive the second hole, and the second rigid extension has a second recess to receive the first hole.

20. The fastener as recited in claim 19, wherein the recesses are U-shaped.

21. The fastener as recited in claim 12, wherein the base comprises recesses on opposite sides to receive a bicycle frame on one side and a lock on the other side.

22. A fastener, comprising
a base having a first lateral side, an opposing second lateral side, a top side and a bottom side, the top side and first lateral side meeting at a first end, the bottom side and second lateral side meeting at a second end;
a first rigid extension extending outward from the first lateral side;
a second rigid extension extending outward from the second lateral side;
a first flexible extension having a first hole therein, the first flexible extension extending from first end, the first flexible extension being sized to wrap over an article to be secured to the top side and to have the first hole secured to the second rigid extension;
a second flexible extension having a second hole therein, the second flexible extension extending from the second end, the first flexible extension being sized to wrap over an article to be secured to the bottom side and to have the second hole secured to the first rigid extension.
